(19) United States
(12) Patent Application Publication
(10) Pub. No.: US 2025/0193520 A1
(43) Pub. Date: Jun. 12, 2025

(54) IMAGE PROCESSING APPARATUS AND METHOD, IMAGE CAPTURING APPARATUS, AND STORAGE MEDIUM

(71) Applicant: CANON KABUSHIKI KAISHA, Tokyo (JP)

(72) Inventor: TAKAYUKI SUZUKI, Kanagawa (JP)

(21) Appl. No.: 18/967,752

(22) Filed: Dec. 4, 2024

(30) Foreign Application Priority Data
Dec. 6, 2023 (JP) 2023-206276

(51) Int. Cl. H04N 23/67; G06T 5/70; H04N 23/611; H04N 23/667

(52) U.S. Cl. CPC H04N 23/675; G06T 5/70; H04N 23/611; H04N 23/667; G06T 2207/30201

(57) ABSTRACT

An image processing apparatus sets whether or not to execute a predetermined correction process on a correction target region in an image input via an input unit, and sets a first correction amount in a case where the correction process is to be executed; determines whether a predetermined condition is satisfied, and, if so, further determines whether the first correction amount is a predetermined threshold or more; changes the first correction amount to a second correction amount smaller than the first correction amount if the first correction amount is the threshold or more; and, if the execution of the correction process is set, executes the correction process on the correction target region of the image based on the second correction amount, or on the first correction amount if the first correction amount is not changed to the second correction amount.

### CROSS-REFERENCE TO PRIORITY APPLICATION

This application claims the benefit of Japanese Patent Application No. 2023-206276, filed Dec. 6, 2023, which is hereby incorporated by reference herein in its entirety.

### BACKGROUND OF THE INVENTION

### Field of the Invention

The present invention relates to an image processing apparatus and method, image capturing apparatus, and storage medium, and in particular to control of a correction amount in skin beautification processing.

### Description of the Related Art

There has been known an image capturing apparatus that performs skin beautification processing on a person's face of an image when capturing the image and records the result. Skin beautification processing is a process that makes the skin appear smoother by reducing roughness and removing dullness and blemishes, but since the resolution of the processed area is reduced, it is necessary to apply the effect at an appropriate level.

For example, in the Japanese Patent No. 5083116, a technology is disclosed that corrects an image when a specific area is detected in the image, using a correction strength corresponding to a pre-set correction level.

Furthermore, Japanese Patent Laid-Open No. 2003-18451 discloses a technique for invalidating or reducing contour correction for a specific hue when the focus mode is manual and focus adjustment is in progress.

On the other hand, in recent years, users have been demanding shooting modes and autofocus operations suitable for product reviews. In product reviews, the product being introduced is the main subject, so AF that quickly focuses on a subject in the foreground (hereinafter referred to as “review AF”) is required, rather than face-priority AF that tracks the face of a person or fixed focus on one point on the screen.

However, with the review AF, there are cases where the focus is not set on a person's face, and the application of the conventional techniques disclosed in the above-mentioned Japanese Patent No. 5083116 and Japanese Patent Laid-Open No. 2003-18451 cannot achieve the expected skin beautification effect.

### SUMMARY OF THE INVENTION

The present invention has been made in consideration of the above situation, and makes it possible to achieve a skin beautification effect desired by a user for a person who is not in an in-focus state.

According to the present invention, provided is an image processing apparatus comprising one or more processors and/or circuitry which function as: an input unit that inputs an image; a setting unit that sets whether or not to execute a predetermined correction process on a correction target region having a predetermined characteristic in the image, and a first correction amount in a case where the correction process is to be executed; a determination unit that determines whether a predetermined condition is satisfied, and, if the condition is satisfied, determines whether the first correction amount is equal to or greater than a predetermined threshold; a changing unit that changes the first correction amount to a second correction amount smaller than the first correction amount in a case where the determination unit determines that the first correction amount is equal to or greater than the threshold; and a correction unit that, if the execution of the correction process is set, executes the correction process on the correction target region of the image based on the second correction amount, or based on the first correction amount if the first correction amount is not changed to the second correction amount by the changing unit.

Further, according to the present invention, provided is an image capturing apparatus comprising: an image capturing unit that shoots an image and outputs it; and an image processing apparatus comprising one or more processors and/or circuitry which function as: an input unit that inputs the image; a setting unit that sets whether or not to execute a predetermined correction process on a correction target region having a predetermined characteristic in the image, and a first correction amount in a case where the correction process is to be executed; a determination unit that determines whether a predetermined condition is satisfied, and, if the condition is satisfied, determines whether the first correction amount is equal to or greater than a predetermined threshold; a changing unit that changes the first correction amount to a second correction amount smaller than the first correction amount in a case where the determination unit determines that the first correction amount is equal to or greater than the threshold; and a correction unit that, if the execution of the correction process is set, executes the correction process on the correction target region of the image based on the second correction amount, or based on the first correction amount if the first correction amount is not changed to the second correction amount by the changing unit.

Furthermore, according to the present invention, provided is an image processing apparatus comprising one or more processors and/or circuitry which function as: inputting an image; setting whether or not to execute a predetermined correction process on a correction target region having a predetermined characteristic in the image, and a first correction amount in a case where the correction process is to be executed; determining whether a predetermined condition is satisfied, and, if the condition is satisfied, determining whether the first correction amount is equal to or greater than a predetermined threshold; changing the first correction amount to a second correction amount smaller than the first correction amount in a case where the first correction amount is determined to be equal to or greater than the threshold; and if the execution of the correction process is set, executing the correction process on the correction target region of the image based on the second correction amount, or based on the first correction amount if the first correction amount is not changed to the second correction amount.

Further, according to the present invention, provided is a non-transitory computer-readable storage medium, the storage medium storing a program that is executable by the computer, wherein the program includes program code for causing the computer to function as an image processing apparatus comprising: an input unit that inputs an image; a setting unit that sets whether or not to execute a predetermined correction process on a correction target region having a predetermined characteristic in the image, and a first correction amount in a case where the correction process is to be executed; a determination unit that determines whether a predetermined condition is satisfied, and, if the condition is satisfied, determines whether the first correction amount is equal to or greater than a predetermined threshold; a changing unit that changes the first correction amount to a second correction amount smaller than the first correction amount in a case where the determination unit determines that the first correction amount is equal to or greater than the threshold; and a correction unit that, if the execution of the correction process is set, executes the correction process on the correction target region of the image based on the second correction amount, or based on the first correction amount if the first correction amount is not changed to the second correction amount by the changing unit.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram illustrating an appearance of an image capturing apparatus according to an embodiment of the present invention.

FIG. 2 is a block diagram illustrating a functional configuration of the image capturing apparatus according to the embodiment.

FIG. 3 is a flowchart illustrating skin beautification amount setting processing according to a first embodiment.

FIG. 4 is a flowchart illustrating skin beautification amount correction processing according to the first embodiment.

FIG. 5 is a flowchart illustrating skin beautification amount setting processing according to a second embodiment.

FIGS. 6A and 6B are diagrams explaining relationship between a distance between a face position and an in-focus position, and a skin beautification amount according to the second embodiment.

FIG. 7 is a flowchart illustrating skin beautification amount setting processing according to a third embodiment.

FIG. 8 is a flowchart illustrating skin beautification amount setting processing according to a fourth embodiment.

FIGS. 9A and 9B are diagrams illustrating relationship between an in-focus position and a subject position in AF mode.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

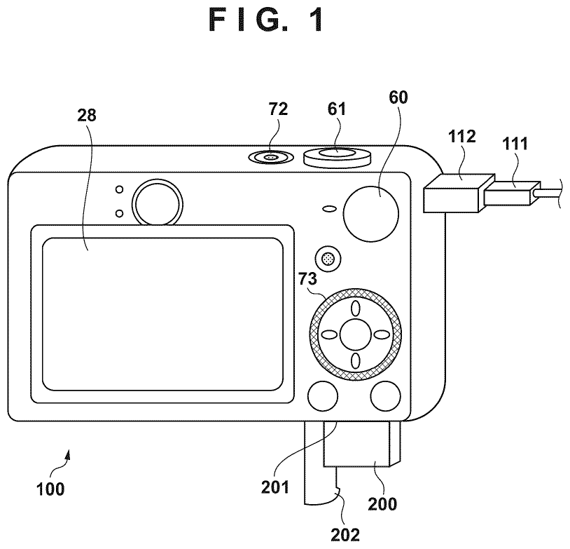

FIG. 1 is a block diagram illustrating the configuration of an image capturing apparatus 100 having an image processing function according to an embodiment of the present invention. In this embodiment, a digital camera is used as an example of the image capturing apparatus 100, but any electronic device with a camera function may be used, such as a digital video camera or other camera, a mobile phone with a camera, a computer with a camera, a game machine, etc.

A display unit 28 is provided on a rear surface of the image capturing apparatus 100 and displays images and various information. Operation members include a shutter button 61 for issuing shooting instructions, a mode changeover switch 60 for switching between various modes, a power switch 72 for switching the power on/off, a rotatable controller wheel 73, other buttons, a touch panel, and other operation members. Instructions from the user are accepted via various operations on the operation members.

A connector 112 is a connector between a connection cable 111 and the image capturing apparatus 100.

A recording medium 200 is a recording medium such as a memory card, a hard disk, or the like, and is inserted in a recording medium slot 201. The recording medium 200 inserted in the recording medium slot 201 is capable of communicating with the image capturing apparatus 100. A lid 203 is a lid of the recording medium slot 201.

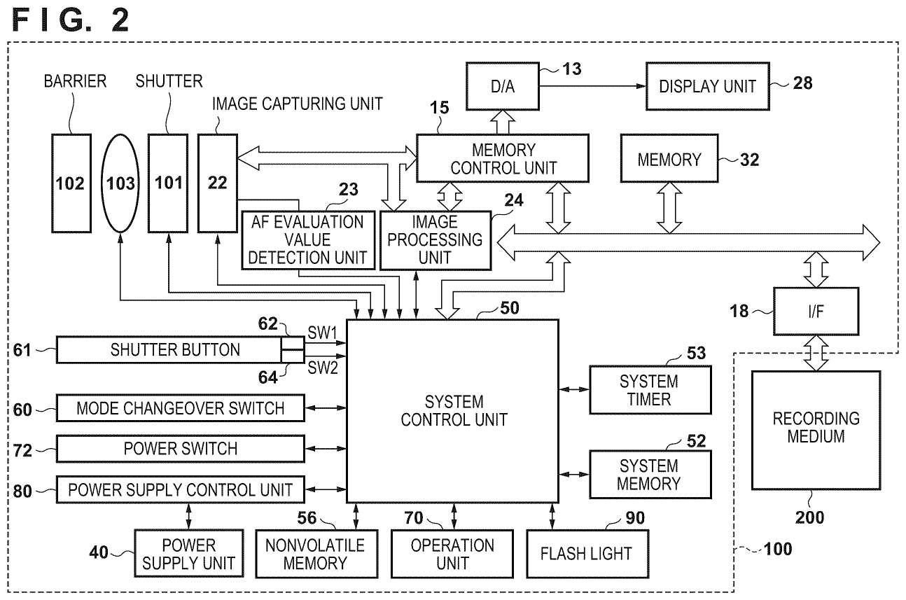

FIG. 2 is a block diagram showing a functional configuration of the image capturing apparatus 100 in this embodiment.

In FIG. 2, an imaging lens 103 includes a lens group including a zoom lens and a focus lens. A shutter 101 is a shutter with an aperture function. Note that, here, the imaging lens 103 is described as being configured integrally with the image capturing apparatus 100, but the present invention is not limited to this, and the imaging lens 103 may be configured to be detachable from the image capturing apparatus 100.

An image capturing unit 22 is composed of a CCD or CMOS element, and has an A/D conversion processing function. It converts an optical image formed on the imaging surface via the imaging lens 103 and the shutter 101 into an electrical signal, A/D converts the obtained electrical signal, and outputs a digital image signal (image data).

An AF evaluation value detection unit 23 calculates an AF evaluation value from contrast information, phase difference information, etc. obtained from the digital image signal output from the image capturing unit 22, and outputs the obtained AF evaluation value from the AF evaluation value detection unit 23 to a system control unit 50. In a case of outputting the phase difference information, at least some of the pixels constituting the image capturing unit 22 are configured to be able to acquire phase difference information, such as by having a biased light receiving area or being divided into a plurality of light receiving areas.

A barrier 102 is a protective member that covers the imaging system of the image capturing apparatus 100, including the imaging lens 103, shutter 101, and image capturing unit 22, to prevent the imaging system from becoming dirty or damaged.

A flash light 90 is illuminated when shooting a low-luminance scene or a backlit scene to compensate for the lack of brightness.

An image processing unit 24 performs various image processing such as predetermined pixel interpolation processing, resizing processing such as reduction/enlargement, color conversion processing, skin beautification processing, etc., on the image data output from the image capturing unit 22 or image data output via a memory control unit 15. In addition, the image processing unit 24 performs predetermined image processing and calculation processing using the image data obtained by shooting, and the system control unit 50 performs exposure control and focus control based on the obtained calculation results. As a result, the through-the-lens (TTL) type automatic exposure (AE) processing and automatic flash light emission (EF) processing are performed. Note that autofocus (AF) processing may be performed in the image processing unit 24 instead of the AF evaluation value detection unit 23.

Furthermore, the image processing unit 24 performs predetermined calculation processing using the image data captured by the image capturing unit 22, and also performs TTL type auto white balance (AWB) processing based on the obtained calculation results.

The output data output from the image capturing unit 22 is written to a memory 32 via the image processing unit 24 and the memory control unit 15, or directly via the memory control unit 15. The memory 32 also serves as a memory for image display (video memory), and has a storage capacity sufficient to store a predetermined number of still images and a predetermined period of moving images and audio, and stores image data output from the image capturing unit 22 and image data to be displayed on the display unit 28.

The image data for display written in the memory 32 is converted into an analog signal by a D/A converter 13 and displayed on a display such as an LCD of the display unit 28. The digital image signal that has been A/D converted by the image capturing unit 22 and stored in the memory 32 is converted into an analog signal by the D/A converter 13 and sequentially transferred to and displayed on the display unit 28, thereby realizing an electronic viewfinder and enabling through-image display.

A nonvolatile memory 56 is an electrically erasable and recordable memory, such as a flash memory, that stores constants and programs for operation of the system control unit 50. The programs stored in the nonvolatile memory 56 include programs for performing processes in various flowcharts described later in this embodiment.

The system control unit 50 is a control unit consisting of at least one processor or circuit, and controls the entire image capturing apparatus 100. The system control unit 50 realizes each process described below by executing programs recorded in nonvolatile memory 56. A system memory 52, for example, may be a RAM, and constants and variables used in the operation of the system control unit 50, programs read from nonvolatile memory 56, etc. are deployed in it. The system control unit 50 also controls display by controlling the memory 32, D/A converter 13, display unit 28, and so on.

A system timer 53 is a time measuring unit that measures the time used for various controls and the time of a built-in clock.

The mode changeover switch 60, the shutter button 61, and an operation unit 70 are operating members for inputting various operational instructions to the system control unit 50. The operation unit 70 also includes controller wheel 73 shown in FIG. 1 as well as other buttons, a touch panel, etc.

The power switch 72 can be used to switch between power-on and power-off modes of the image capturing apparatus 100.

The mode changeover switch 60 switches the operating mode of the system control unit 50 to one of still image recording mode, moving image recording mode, playback mode, etc.

The still image recording mode has as its sub-modes an auto shooting mode, an auto scene determination mode, a manual mode, various scene modes which provide shooting settings according to the shooting scene, a programmed AE mode, a custom mode, and so on.

The mode changeover switch 60 can be used to directly switch to one of these sub-modes of the still image recording mode. Alternatively, after switching to the still image recording mode with the mode changeover switch 60, another operating member can be used to switch to one of the sub-modes of the still image recording mode.

Similarly, in this embodiment, the moving image recording mode also includes a plurality of sub-modes of skin beautification moving image mode and a product review moving image mode in addition to sub-modes similar to those of the still image recording mode.

The skin beautification moving image mode is a mode in which skin beautification processing is performed as image processing on a face detected in an image, and a face priority AF mode is set as an AF mode (mode related to focus adjustment) which prioritizes focusing on a face among subjects present within the shooting angle of view, as a default. However, in the skin beautification moving image mode, the AF mode can be changed to another AF mode.

The product review moving image mode is a mode in which a review AF mode is set with the aim of prioritizing focusing on a product among the subjects present within the shooting angle of view, and instead of tracking a person or a specific subject, the focus is on an object that is closer to the image capturing apparatus 100. On the other hand, it is possible to change whether or not to perform the skin beautification processing as image processing.

Note that it may also be possible to configure the image capturing apparatus 100 so that whether or not to perform the skin beautification processing can be set in sub-modes of the moving image recording mode other than the aforesaid moving image sub-modes.

A first shutter switch 62 is turned on by half-pressing the shutter button 61 (shooting preparation instruction) and generates a first shutter switch signal SW1. The first shutter switch signal SW1 initiates preparation operations for shooting such as AF processing, AE processing, AWB processing, and EF processing.

A second shutter switch 63 is turned ON when the shutter button 61 is fully pressed (shooting instruction) and generates a second shutter switch signal SW2. In response to the second shutter switch signal SW2, the system control unit 50 starts a series of shooting processing operations, from reading out a signal from the image capturing unit 22 to writing the obtained image data to the recording medium 200 as an image file.

Each operation member of the operation unit 70 is assigned a function according to the display contents as any of various function icons displayed on the display unit 28 is selected, and acts as various function buttons. Examples of the function buttons include an end button, a back button, an image forward button, a jump button, a filter button, and an attribute change button. For example, when a menu button is pressed, a menu screen in which various settings can be made is displayed on the display unit 28. The user can intuitively make various settings using the menu screen displayed on the display unit 28, four directional buttons (up, down, left, and right) and a SET button.

The controller wheel 73 is a rotatable operating member included in the operation unit 70, and is used together with the directional buttons to select an item. When the controller wheel 73 is rotated, an electrical pulse signal is generated according to the amount of rotation, and the system control unit 50 controls each part of the image capturing apparatus 100 based on this pulse signal. This pulse signal makes it possible to determine the angle at which the controller wheel 73 is rotated and the number of rotations. The controller wheel 73 may be any operating member capable of detecting a rotation operation. For example, the controller wheel 73 may be a dial operating member that generates a pulse signal by rotating itself in response to a rotation operation by the user. Alternatively, the controller wheel 73 may be an operating member made of a touch sensor that does not rotate itself but detects the rotation of the user's finger on the controller wheel 73 (a so-called touch wheel).

In this embodiment, the operation unit 70 described above can be used to set whether or not to perform the skin beautification processing by the image processing unit 24. The skin beautification processing is processing for removing or reducing wrinkles and dullness, and blending dark circles under the eyes with the surrounding skin color in a person's face (area to be corrected) in a captured image, and includes smoothing processing using a smoothing filter, for example. In addition, processing for reducing bloodshot eyes and correcting teeth to be white may be performed. The strength of the skin beautification processing is divided in multiple levels, and can be set by the user using the operation unit 70 as a skin beautification effect setting value. Setting information regarding whether or not to perform the skin beautification processing and the skin beautification effect setting value that have been set are stored in the memory 32.

Note that the various processes related to the skin beautification processing are all well-known technologies in the technical field of image processing, so detailed explanations will be omitted here.

A power supply control unit 80 is made up of a battery detection circuit, a DC-DC converter, a switch circuit that switches between blocks to which power is supplied, etc., and detects whether a battery is installed, the battery type, and the remaining battery power. The power supply control unit 80 also controls the DC-DC converter based on the detection results and instructions from the system control unit 50, and supplies the necessary voltage to each section including the recording medium 200 for the necessary period of time.

A power supply unit 40 may be primary batteries such as alkaline batteries or lithium batteries, secondary batteries such as NiCd batteries, NiMH batteries, or Li batteries, an AC adapter, etc.

A recording medium I/F 18 is an interface with a recording medium 200 such as a memory card or a hard disk. The recording medium 200 is a recording medium such as a memory card for recording captured images, and is composed of a semiconductor memory, a magnetic disk, or the like.

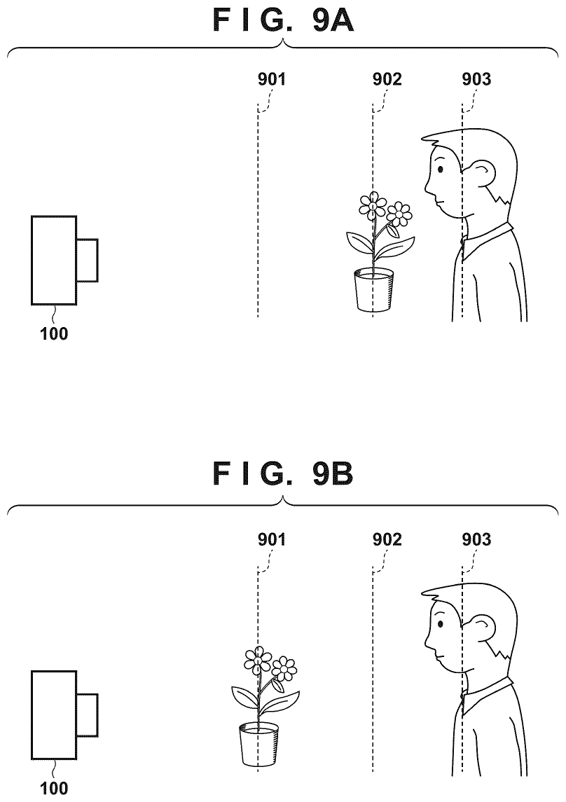

FIGS. 9A and 9B are diagrams illustrating an autofocus operation and the distance to a person.

In FIG. 9A, the image capturing apparatus 100 performs a focusing operation to focus on a position on a plane 903 where the face is located in face-priority AF, or on a position on a plane 902 where the product is located in review AF. In this case, because the distance between the person and the product is short, even if the focus is on a position on the plane 902, it is possible to achieve a suitable skin beautification effect for the person through the skin beautification processing.

On the other hand, in FIG. 9B, the product is closer to the image capturing apparatus 100 than in FIG. 9A, and the position to be focused on during the review AF is a position on a plane 901. In this case, the person located on the plane 903 is out of focus. However, if a face is detected in the captured image, and the skin beautification processing is further applied to the out-of-focus face, the sense of resolution will be further reduced and the person will become too blurred.

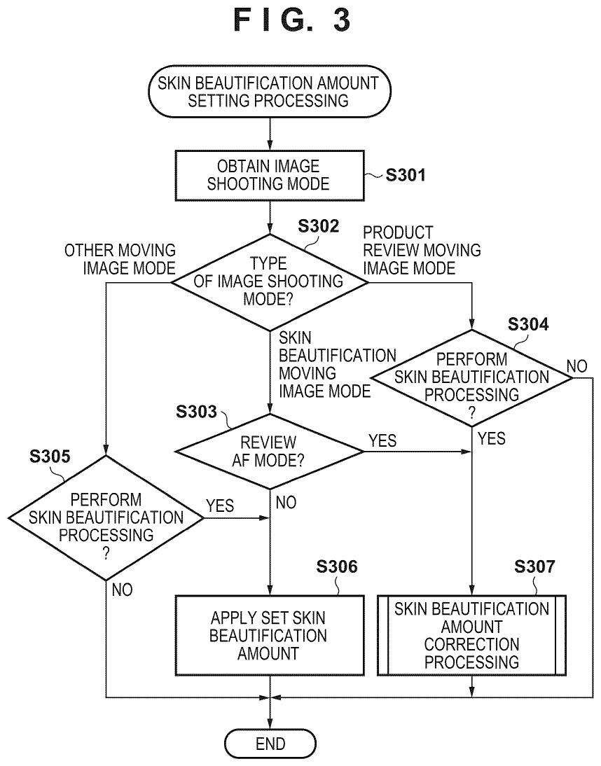

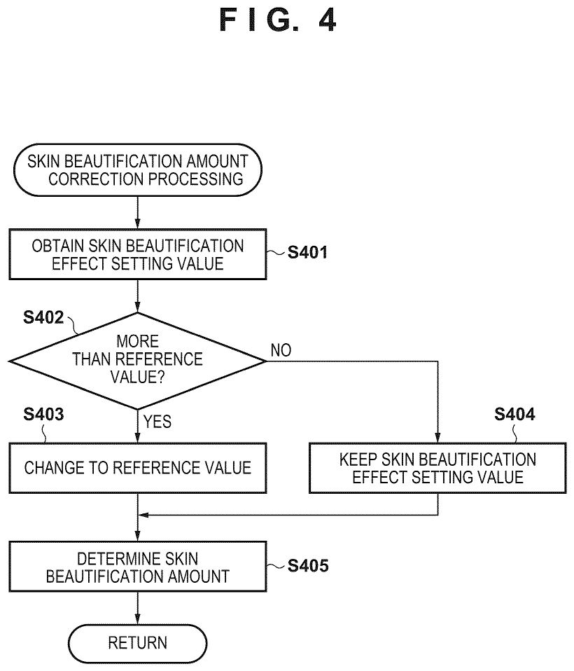

Next, processing for correcting a skin beautification amount in the first embodiment will be described with reference to FIGS. 3 and 4.

FIG. 3 is a flowchart illustrating skin beautification amount setting processing performed in the image capturing apparatus 100 according to the first embodiment. Note that each process in this flowchart is realized by the system control unit 50 expanding a program stored in the nonvolatile memory 56 into the system memory 52 and executing the program.

When the skin beautification amount setting processing is started, the system control unit 50 acquires the set shooting mode in step S301. Then, in step S302, the acquired shooting mode is judged, and if it is a skin beautification moving image mode, the process proceeds to step S303, if it is a product review moving image mode, the process proceeds to step S304, and if it is any other mode, the process proceeds to step S305. In step S305, it is judged whether or not the skin beautification processing is to be performed, and if it is to be performed, the process proceeds to step S306, and if it is not to be performed, the processing ends.

In step S303, it is determined whether the review AF mode is set as the AF mode (condition). If the review AF mode is not selected, for example, it is assumed that the default face priority AF mode is selected and the process proceeds to step S306, and if the review AF mode is set, the process proceeds to step S307.

In step S306, the system control unit 50 reads out the set skin beautification effect setting value, applies the skin beautification amount (correction amount) associated with the read out skin beautification effect setting value, and ends the processing.

On the other hand, in step S304, it is determined whether the skin beautification processing is set to be performed as the image processing, and if the skin beautification processing is not to be performed, the processing ends, and if it is to be performed, the process proceeds to step S307.

In step S307, the skin beautification amount correction processing is performed. Note that details of the skin beautification amount correction processing performed in step S307 will be described later with reference to FIG. 4.

FIG. 4 is a flowchart showing the skin beautification amount correction processing performed in step S307 of FIG. 3.

When the skin beautification amount correction processing is started, the system control unit 50 obtains the set skin beautification effect setting value in step S401. Next, the system control unit 50 compares the skin beautification effect setting value with a predetermined reference value in step S402. If a set strength of the skin beautification effect setting value is stronger than the reference value, the system control unit 50 changes the skin beautification effect setting value to the reference value in step S403. Note that the skin beautification effect setting value does not necessarily have to be changed to the reference value, and a skin beautification amount that can reduce the skin beautification effect compared with the currently set skin beautification effect setting value is sufficient.

On the other hand, if it is determined in step S402 that the skin beautification effect setting value is equal to or less than the reference value, then in step S404 the set skin beautification effect setting value is maintained.

Then, in step S405, the system control unit 50 calculates the skin beautification amount (correction amount) to be actually applied to the image based on the skin beautification effect setting value determined in step S403 or S404, and ends the processing.

Through the above processing, even if the product review mode and the skin beautification processing are used in combination, the user can obtain an image with a suitable skin beautification effect by correcting the skin beautification amount under the product review mode as necessary based on the AF mode and skin beautification effect setting value.

In this embodiment, two cases have been described: a case where the shooting mode is the product review moving image mode and the setting is to perform the skin beautification processing, and a case where the shooting mode is the skin beautification moving image mode and the AF mode is set to the review AF mode. However, the hierarchy of modes and settings is not limited to this, and it is possible to correct the skin beautification amount in a case of using an AF setting that does not necessarily prioritize faces and the skin beautification processing in combination.

In this embodiment, the skin beautification amount is corrected by correcting the skin beautification effect setting value, but the skin beautification amount may also be corrected by a method of directly attenuating the processing parameters of each process in the skin beautification processing, without correcting the skin beautification effect setting value.

In addition, when performing skin beautification in step S306, the skin beautification amount may be varied according to the shooting mode information determined in step S301. For example, if the skin beautification moving image mode is determined in step S301, the skin beautification amount may be suppressed more than in a case where the product review moving image mode is determined. This is because, in the skin beautification moving image mode, it is presumed that the photographer places priority on the image quality of the face area, and therefore there is a strong need to suppress excessive correction of the face area by skin beautification.

On the other hand, if the product review moving image mode is determined in step S301, the skin beautification amount may be suppressed more than in a case where the skin beautification moving image mode is determined. This is because, in the product review moving image mode, it is presumed that the product introduction takes precedence over the beauty of the face area, and therefore it is highly necessary to prevent the entire image from becoming a failed image due to overcorrection of the face area.

### Second Embodiment

Next, a second embodiment of the present invention will be described. In the second embodiment, a case where the skin beautification amount is corrected based on information of a captured image will be described. Note that the second embodiment also uses the image capturing apparatus 100 described in the first embodiment, and therefore the description thereof is omitted.

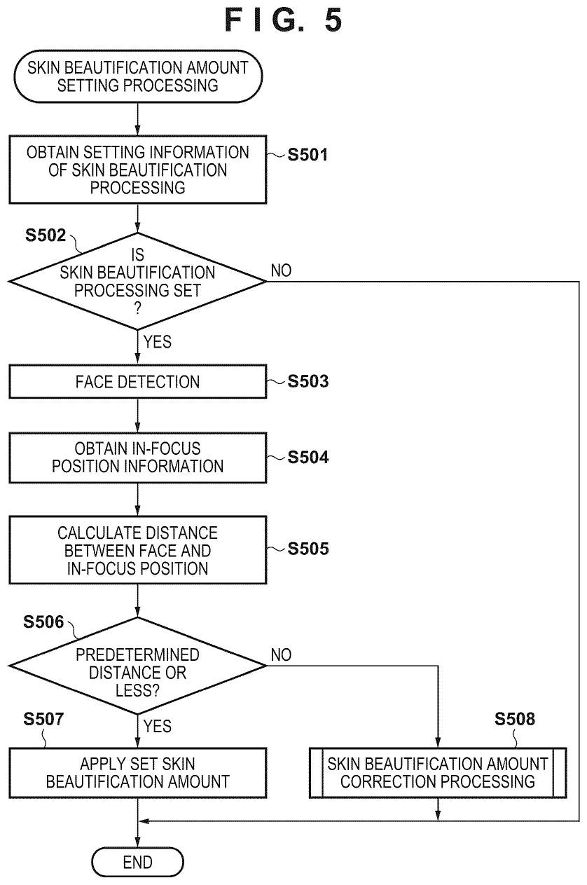

FIG. 5 is a flowchart illustrating skin beautification amount setting processing performed in the image capturing apparatus 100 according to the second embodiment. Note that each process in this flowchart is realized by the system control unit 50 expanding a program stored in the nonvolatile memory 56 into the system memory 52 and executing the program.

When the skin beautification amount correction processing is started, the system control unit 50 acquires setting information of the skin beautification processing in step S501, and judges whether or not the skin beautification processing is set based on the acquired setting information of the skin beautification processing in step S502. If the skin beautification processing is not set, the processing ends as it is. On the other hand, if it is judged that the skin beautification processing is set in step S502, the system control unit 50 advances the process to step S503.

In step S503, the system control unit 50 performs face detection processing on the captured image, and stores the coordinates of the detected face position in the memory 32. Next, in step S504, the system control unit 50 acquires in-focus position information indicating which position in the image was focused on when capturing the image. Note that the order of the processes of steps S503 and S504 may be reversed, or the processes may be performed in parallel. Then, in step S505, the system control unit 50 calculates the distance on the image between the coordinates of the face position stored in the memory 32 and the coordinates of the in-focus position.

In step S506, the system control unit 50 judges whether or not the calculated distance between the face position and the in-focus position is equal to or less than a predetermined distance (condition). If it is equal to or less than the predetermined distance, the system control unit 50 applies the skin beautification amount associated with the skin beautification effect setting value in step S507, and ends the processing. On the other hand, if it is judged in step S506 that it exceeds the predetermined distance, the system control unit 50 executes the skin beautification amount correction processing in step S508. Note that, as the skin beautification amount correction processing, for example, the same processing as that described with reference to FIG. 4 is performed.

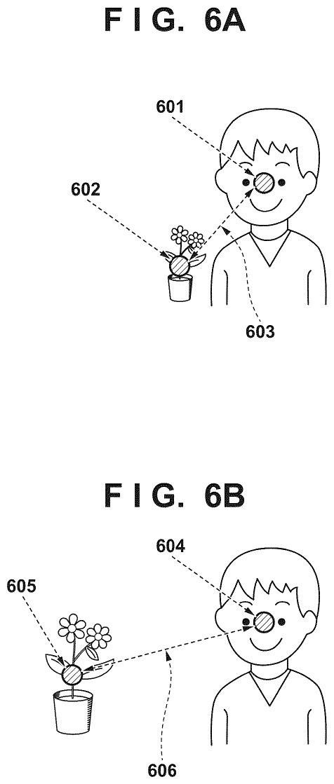

FIGS. 6A and 6B are diagrams for explaining the relationship between the distance between the face position and the in-focus position, and the skin beautification amount in the second embodiment. Reference numerals 601 and 604 indicate the center position of the face, 602 and 605 indicate the in-focus position at the time of shooting, and 603 and 606 indicate the distance on the image between the center position of the face and the in-focus position.

In FIG. 6A, the distance on the image between the center position 601 of the face and the in-focus position 602 is short.

On the other hand, in FIG. 6B, the distance on the image between the center position 604 of the face and the in-focus position 605 is long, and compared to a case where the distance is short as in FIG. 6A, the face is more likely to be outside the depth of field and out of focus. However, since face detection is successful, the skin beautification processing is applied. In the second embodiment, the skin beautification amount is reduced in such scenes, making it possible to prevent excessive skin beautification effects on a face.

### Third Embodiment

Next, a third embodiment of the present invention will be described. In the third embodiment, a case where the skin beautification amount is corrected based on the depth of field will be described. Note that the third embodiment also uses the image capturing apparatus 100 described in the first embodiment, and therefore the description thereof is omitted.

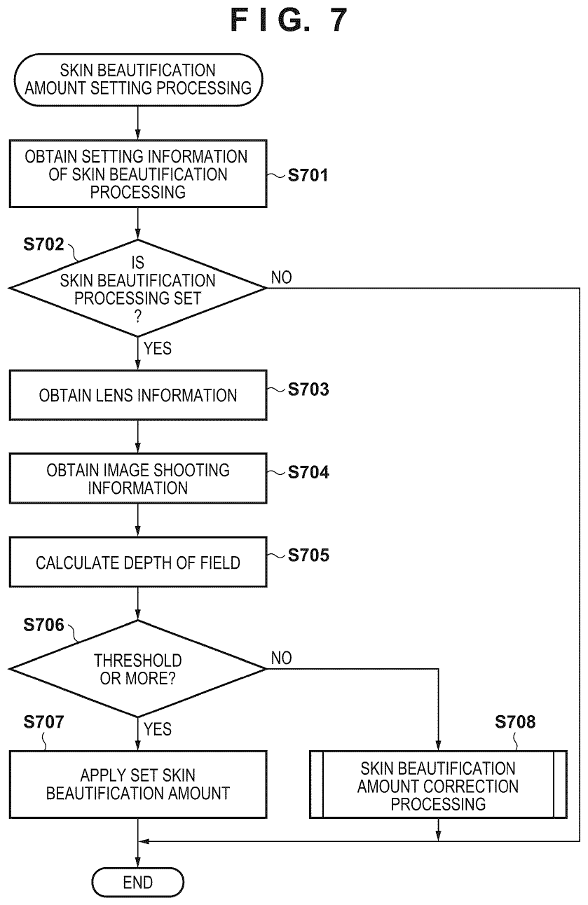

FIG. 7 is a flowchart illustrating skin beautification amount setting processing performed in the image capturing apparatus 100 according to the third embodiment. Note that each process in this flowchart is realized by the system control unit 50 expanding a program stored in the nonvolatile memory 56 into the system memory 52 and executing it. In addition, in the following description, it is assumed that the imaging lens 103 is detachable from the image capturing apparatus 100.

When the skin beautification amount correction processing is started, the system control unit 50 acquires setting information of the skin beautification processing in step S701, and judges whether or not the skin beautification processing is set based on the acquired setting information of the skin beautification processing in step S702. If the skin beautification processing is not set, the processing ends as it is. On the other hand, if it is judged that the skin beautification processing is set in step S702, the system control unit 50 advances the process to step S703.

In step S703, the system control unit 50 acquires lens information of the imaging lens 103 attached to the image capturing apparatus 100. If the imaging lens 103 is a lens integrated with the image capturing apparatus 100, the system control unit 50 uses lens information that has been stored in advance in the memory 32 or the like. Next, in step S704, the system control unit 50 acquires image shooting information including the F-number, the distance to the in-focus point, and the depth of focus.

In step S705, the system control unit 50 calculates the depth of field at the time of shooting from the lens information and image shooting information, and in step S706, judges whether the depth of field is equal to or greater than a predetermined threshold (condition). If it is judged that the depth of field is equal to or greater than the threshold, the system control unit 50 applies the skin beautification amount associated with the skin beautification effect setting value in step S707, and ends the processing. On the other hand, if it is judged that the depth of field is less than the threshold in step S706, the system control unit 50 performs skin beautification amount correction processing in step S708. Note that, as the skin beautification amount correction processing, for example, the same processing as the processing described with reference to FIG. 4 is performed.

When the depth of field is deep during shooting, there is a high possibility that a person exists within the depth of field, but when the depth of field is shallow, there is a low possibility that a person exists within the depth of field, so a person is likely to be blurred. However, since face detection is successful, the skin beautification processing is applied. In the third embodiment, the skin beautification amount is reduced in such scenes, making it possible to prevent excessive skin beautification effect on a face.

### Fourth Embodiment

Next, a fourth embodiment of the present invention will be described. In the fourth embodiment, a case where the skin beautification amount is corrected based on the depth of field and the distance to a face will be described. Note that the fourth embodiment also uses the image capturing apparatus 100 described in the first embodiment, and a description thereof is omitted.

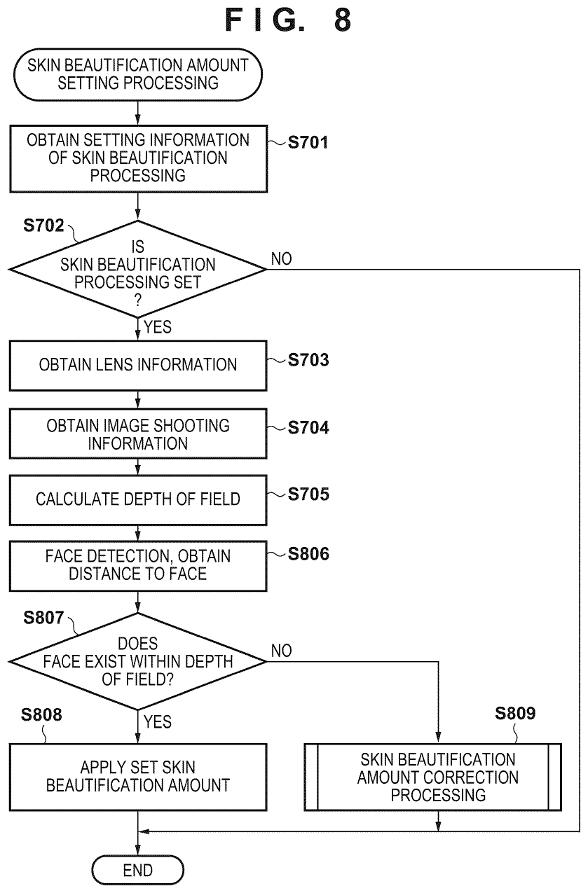

FIG. 8 is a flowchart showing skin beautification amount setting processing performed in the image capturing apparatus 100 according to the fourth embodiment. Note that each process in this flowchart is realized by the system control unit 50 expanding a program stored in the nonvolatile memory 56 into the system memory 52 and executing it. In the following description, the imaging lens 103 is described as being detachable from the image capturing apparatus 100.

The processes from steps S701 to S705 in FIG. 8 are the same as those shown in FIG. 7, and therefore the description thereof is omitted.

In step S806, the system control unit 50 performs face detection processing on the captured image, and obtains the distance to the detected face (distance measurement) based on the phase difference information detected by the AF evaluation value detection unit 23. Next, in step S807, the system control unit 50 determines whether the detected face is within the depth of field (condition) based on the distance to the in-focus point acquired in step S703, the depth of field acquired in step S705, and the distance to the face acquired in step S806.

In step S807, if the detected face is within the depth of field, the skin beautification amount associated with the skin beautification effect setting value is applied in step S808, and the processing ends. On the other hand, if it is determined in step S807 that the face is not within the depth of field, the system control unit 50 performs skin beautification amount correction processing in step S809. Note that, as the skin beautification amount correction processing, for example, the same processing as that described with reference to FIG. 4 is performed.

In the above processing, the distance to the in-focus point and the distance to the face are detected separately, but it is also possible to determine whether each face is within the depth of field by generating a so-called defocus map that shows the distance to each subject.

According to the fourth embodiment, in a scene in which a person is present outside the depth of field and appears slightly blurred, but face detection is successful, the skin beautification amount is reduced, thereby making it possible to prevent excessive skin beautification effect on a face.

In the above-mentioned first to fourth embodiments, the skin beautification processing is performed within the image capturing apparatus, but the present invention is not limited to this. For example, a computer, a tablet terminal, or the like may be used as an image processing apparatus that acquires image data captured by the image capturing apparatus and performs the skin beautification processing on the acquired image data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising one or more processors and/or circuitry which function as:
an input unit that inputs an image;
a setting unit that sets whether or not to execute a predetermined correction process on a correction target region having a predetermined characteristic in the image, and a first correction amount in a case where the correction process is to be executed;
a determination unit that determines whether a predetermined condition is satisfied, and, if the condition is satisfied, determines whether the first correction amount is equal to or greater than a predetermined threshold;
a changing unit that changes the first correction amount to a second correction amount smaller than the first correction amount in a case where the determination unit determines that the first correction amount is equal to or greater than the threshold; and
a correction unit that, if the execution of the correction process is set, executes the correction process on the correction target region of the image based on the second correction amount, or based on the first correction amount if the first correction amount is not changed to the second correction amount by the changing unit.

2. The image processing apparatus according to claim 1, wherein the one or more processors and/or circuitry further functions as:
a selection unit that selects one of a plurality of modes relating to focus adjustment, including a review AF mode for selecting and focusing on a subject that is close to an image capturing apparatus among subjects present within an angle of view,
wherein the determination unit determines that the condition is satisfied in a case where the review AF mode is selected.

3. The image processing apparatus according to claim 1, wherein the determination unit determines that the condition is satisfied in a case where a distance between a position of the correction target region and an in-focus position in the image is longer than a predetermined distance.

4. The image processing apparatus according to claim 1, wherein the one or more processors and/or circuitry further functions as:
an acquisition unit that acquires lens information of an imaging lens used to shoot the image and shooting information used to shoot the image; and
a calculation unit that calculates a depth of field based on the lens information and the shooting information,
wherein the determination unit determines that the condition is satisfied in a case where the depth of field is shallower than a predetermined depth.

5. The image processing apparatus according to claim 1, wherein the one or more processors and/or circuitry further functions as:
an acquisition unit that acquires lens information of an imaging lens used to shoot the image and shooting information used to shoot the image;
a calculation unit that calculates a depth of field based on the lens information and the shooting information; and
a distance measuring unit that obtains a distance to a subject located in the correction target region,
wherein the determination unit determines that the condition is satisfied in a case where the depth of field, which is centered on the distance to an in-focus point included in the shooting information, does not include the distance to the subject.

6. The image processing apparatus according to claim 1, wherein the one or more processors and/or circuitry further functions as:
a detection unit that detects a face region in the image as the correction target region,
wherein the correction unit performs the correction process on the face region.

7. The image processing apparatus according to claim 1, wherein the correction process includes a smoothing process.

8. An image capturing apparatus comprising:
an image capturing unit that shoots an image and outputs it; and
an image processing apparatus comprising one or more processors and/or circuitry which function as:
an input unit that inputs the image;
a setting unit that sets whether or not to execute a predetermined correction process on a correction target region having a predetermined characteristic in the image, and a first correction amount in a case where the correction process is to be executed;
a determination unit that determines whether a predetermined condition is satisfied, and, if the condition is satisfied, determines whether the first correction amount is equal to or greater than a predetermined threshold;
a changing unit that changes the first correction amount to a second correction amount smaller than the first correction amount in a case where the determination unit determines that the first correction amount is equal to or greater than the threshold; and
a correction unit that, if the execution of the correction process is set, executes the correction process on the correction target region of the image based on the second correction amount, or based on the first correction amount if the first correction amount is not changed to the second correction amount by the changing unit.

9. An image processing apparatus comprising one or more processors and/or circuitry which function as:
inputting an image;
setting whether or not to execute a predetermined correction process on a correction target region having a predetermined characteristic in the image, and a first correction amount in a case where the correction process is to be executed;
determining whether a predetermined condition is satisfied, and, if the condition is satisfied, determining whether the first correction amount is equal to or greater than a predetermined threshold;
changing the first correction amount to a second correction amount smaller than the first correction amount in a case where the first correction amount is determined to be equal to or greater than the threshold; and
if the execution of the correction process is set, executing the correction process on the correction target region of the image based on the second correction amount, or based on the first correction amount if the first correction amount is not changed to the second correction amount.

10. A non-transitory computer-readable storage medium, the storage medium storing a program that is executable by the computer, wherein the program includes program code for causing the computer to function as an image processing apparatus comprising:
an input unit that inputs an image;
a setting unit that sets whether or not to execute a predetermined correction process on a correction target region having a predetermined characteristic in the image, and a first correction amount in a case where the correction process is to be executed;
a determination unit that determines whether a predetermined condition is satisfied, and, if the condition is satisfied, determines whether the first correction amount is equal to or greater than a predetermined threshold;
a changing unit that changes the first correction amount to a second correction amount smaller than the first correction amount in a case where the determination unit determines that the first correction amount is equal to or greater than the threshold; and
a correction unit that, if the execution of the correction process is set, executes the correction process on the correction target region of the image based on the second correction amount, or based on the first correction amount if the first correction amount is not changed to the second correction amount by the changing unit.
